(19) United States
(12) Patent Application Publication
(10) Pub. No.: US 2024/0412450 A1
(43) Pub. Date: Dec. 12, 2024

(54) CHECKERBOARD MASK OPTIMIZATION IN OCCLUSION CULLING

(71) Applicant: QUALCOMM Incorporated, San Diego, CA (US)

(72) Inventors: Yunzhen LI, Shenzhen (CN); Duo WANG, Shanghai (CN); Yanshan WEN, Shanghai (CN)

(21) Appl. No.: 18/720,597

(22) PCT Filed: Feb. 22, 2023
(86) PCT No.: PCT/CN2023/077572

§ 371 Date: Jun. 14, 2024

(30) Foreign Application Priority Data
Mar. 1, 2022 (WO) PCT/CN2022/078568

(51) Int. Cl. G06T 15/40; G06T 15/00

(52) U.S. Cl. CPC G06T 15/40; G06T 15/005

(57) ABSTRACT

Aspects presented herein relate to methods and devices for graphics processing including an apparatus, e.g., a GPU or CPU. The apparatus may obtain pixel information for a plurality of pixels in at least one frame included in a plurality of frames in a scene. The apparatus may also calculate a depth value for each of a first set of pixels. Further, the apparatus may identify whether each of the first set of pixels or a second set of pixels, or both, is occluded by at least one occluding object in the scene. The apparatus may configure a pattern mask configuration associated with a visibility mask for the plurality of pixels. The apparatus may also output, based on the pattern mask configuration, an indication of the depth value for the first set of pixels and coverage information for the first set of pixels or the second set of pixels.

### CROSS REFERENCE TO RELATED APPLICATION(S)

This application claims the benefit of and priority to International Application No. PCT/CN2022/078568, entitled “CHECKERBOARD MASK OPTIMIZATION IN OCCLUSION CULLING” and filed on Mar. 1, 2022, which is expressly incorporated by reference herein in its entirety.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), or any apparatus that may perform graphics processing. The apparatus may obtain pixel information for a plurality of pixels in at least one frame, the at least one frame being included in a plurality of frames in a scene. The apparatus may also calculate a depth value for each of a first set of pixels of the plurality of pixels. Additionally, the apparatus may identify whether each of the first set of pixels or a second set of pixels, or both, is occluded by at least one occluding object in the scene, where the second set of pixels is included in the plurality of pixels. The apparatus may also configure a visibility mask prior to configuring a pattern mask configuration associated with the visibility mask. The apparatus may also configure a pattern mask configuration associated with a visibility mask for the plurality of pixels, the pattern mask configuration including a first pattern portion corresponding to the first set of pixels and a second pattern portion corresponding to the second set of pixels. Moreover, the apparatus may generate a binary coverage mask prior to outputting the indication of coverage information for each of the first set of pixels and each of the second set of pixels, and where outputting the indication of coverage information for each of the first set of pixels and each of the second set of pixels, includes: storing the binary coverage mask. The apparatus may also output, based on the pattern mask configuration, an indication of the depth value for each of the first set of pixels and coverage information for each of the first set of pixels or the second set of pixels, or both, where the coverage information is associated with whether each of the first set of pixels or the second set of pixels, or both, is occluded by the at least one occluding object in the scene. Further, the apparatus may retrieve the depth value for the first set of pixels and the coverage information for the first set of pixels and the second set of pixels. The apparatus may also perform an occlusion culling calculation based on the depth value for the first set of pixels and the coverage information for the first set of pixels and the second set of pixels, where the occlusion culling calculation is associated with whether any of the first set of pixels or any of the second set of pixels are not occluded by the at least one occluding object in the scene, where each of the first set of pixels is not occluded by the at least one occluding object if the depth value of the pixel is closer to a viewpoint of the scene than an occluding depth map value, where each of the second set of pixels is not occluded by the at least one occluding object if the coverage information of the pixel is a non-zero value.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 is an example graphics processing unit (GPU).

FIG. 3 is a diagram illustrating an example image or surface used in graphics processing.

FIG. 4 is a diagram illustrating an example image or scene in graphics processing

FIG. 5 is a diagram illustrating an example occluder depth map for graphics processing.

FIG. 6 is a diagram illustrating an example pattern mask configuration for graphics processing.

FIG. 7A is a diagram illustrating an example occluder depth map for graphics processing.

FIG. 7B is a diagram illustrating an example occluder depth map for graphics processing.

FIG. 8 is a diagram illustrating an example occluder depth map for graphics processing.

FIG. 9 is a communication flow diagram illustrating example communications between a CPU, a GPU, and a memory.

FIG. 10 is a flowchart of an example method of graphics processing.

FIG. 11 is a flowchart of an example method of graphics processing.

### DETAILED DESCRIPTION

Some aspects of graphics processing may utilize occlusion culling, which is a feature that disables the rendering of objects when they are not currently seen by a camera because they are obscured (i.e., occluded) by other objects. For instance, occlusion culling may remove objects in a scene from the camera rendering workload if the objects are entirely obscured by objects closer to the camera. In some aspects, the occlusion culling process may pass through the scene using a virtual camera to build a hierarchy of potentially visible sets of objects. This data may be used by each camera in the graphics processing application to identify which objects are visible or not visible. Occlusion culling may increase rendering performance (e.g., GPU rendering) simply by not rendering objects that are outside the viewing area of the camera, or objects that are hidden by other objects closer to the camera. In one instance, the occlusion culling process may be defined as follows: for a camera view in a scene, given a set of occluders (i.e., objects that are occluding other objects) and a set of occludees (i.e., objects that are being occluded by other objects), the visibility of the occludees may be derived or determined. Different areas in occluder depth maps may correspond to data for different pixels. Accordingly, pixels in occluder depth maps may be associated with certain types of pixel information. For instance, pixels in occluder depth maps may include information related to whether the pixel is covered by an occluding object or occluder. Additionally, pixels in occluder depth maps may include information related to the depth value of a pixel. This pixel information in the occluder depth map may correspond to the type of scene in graphics processing. Some types of scenes in graphics processing may be complicated, so there may be a large number of pixels in the scene. Accordingly, as there may be a large amount of pixels in a scene, there may be a large amount of pixel information associated with occluder depth maps. The large amount of pixel information in occluder depth maps may correspond to a large amount of memory that may be needed to store the pixel information. Further, the large amount of pixel information in occluder depth maps may correspond to an extended rendering time for all the pixel information. Aspects of the present disclosure may reduce the amount of pixel information and/or storage space that is associated with occluder depth maps. Also, aspects of the present disclosure may reduce the amount of processing or rendering time associated with pixel information for occluder depth maps. For instance, aspects of the present disclosure may utilize certain types of configurations associated with occluder depth maps. That is, aspects presented herein may utilize different mask configurations associated with occluder depth maps.

Aspects of the present disclosure may include a number of benefits or advantages. For instance, aspects presented herein may result in an improved speed for rendering and depth rasterizations. That is, as a certain amount of pixels (e.g., half of pixels) may need to derive depth information, the checkerboard optimization may result in a faster final depth rasterization. Thus, the total occluder rendering time may be reduced by a certain percentage (e.g., reduced by 5-20% on a mobile platform). As mentioned above, the checkerboard mask optimization may introduce evenly distributed error which is less than one pixel. Occludee query results may be the same compared to the default approach. Checkerboard mask configurations may also optimize the amount of depth buffer memory that is utilized to store the pixel data. For instance, the checkerboard mask optimization described herein may reduce the depth buffer memory by a certain amount (e.g., a reduction of 43.75%).

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

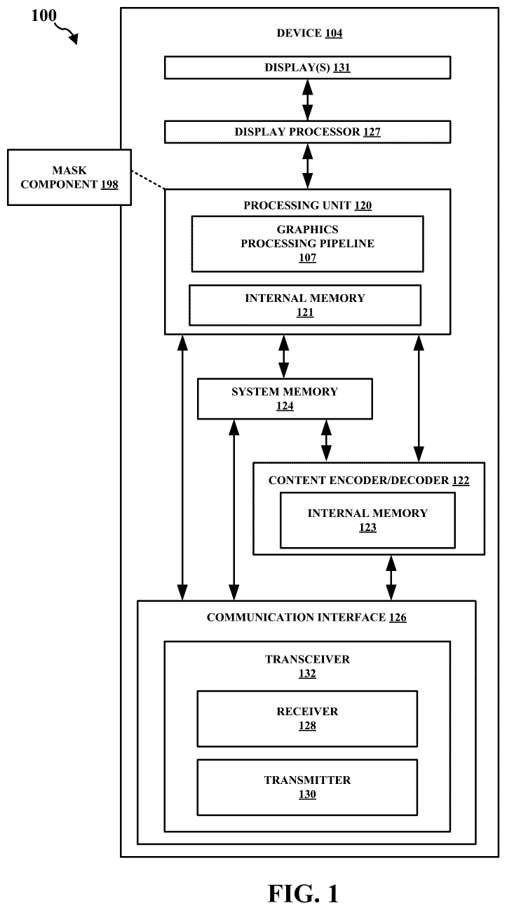

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a mask component 198 configured to obtain pixel information for a plurality of pixels in at least one frame, the at least one frame being included in a plurality of frames in a scene. The mask component 198 may also be configured to calculate a depth value for each of a first set of pixels of the plurality of pixels. The mask component 198 may also be configured to identify whether each of the first set of pixels or a second set of pixels, or both, is occluded by at least one occluding object in the scene, where the second set of pixels is included in the plurality of pixels. The mask component 198 may also be configured to configure a visibility mask prior to configuring a pattern mask configuration associated with the visibility mask. The mask component 198 may also be configured to configure a pattern mask configuration associated with a visibility mask for the plurality of pixels, the pattern mask configuration including a first pattern portion corresponding to the first set of pixels and a second pattern portion corresponding to the second set of pixels. The mask component 198 may also be configured to generate a binary coverage mask prior to outputting the indication of coverage information for each of the first set of pixels and each of the second set of pixels, and where outputting the indication of coverage information for each of the first set of pixels and each of the second set of pixels, or both, includes: storing the binary coverage mask. The mask component 198 may also be configured to output, based on the pattern mask configuration, an indication of the depth value for each of the first set of pixels and coverage information for each of the first set of pixels or the second set of pixels, or both, where the coverage information is associated with whether each of the first set of pixels or the second set of pixels, or both, is occluded by the at least one occluding object in the scene. The mask component 198 may also be configured to retrieve the depth value for the first set of pixels and the coverage information for the first set of pixels and the second set of pixels. The mask component 198 may also be configured to perform an occlusion culling calculation based on the depth value for the first set of pixels and the coverage information for the first set of pixels and the second set of pixels, where the occlusion culling calculation is associated with whether any of the first set of pixels or any of the second set of pixels are not occluded by the at least one occluding object in the scene, where each of the first set of pixels is not occluded by the at least one occluding object if the depth value of the pixel is closer to a viewpoint of the scene than an occluding depth map value, where each of the second set of pixels is not occluded by the at least one occluding object if the coverage information of the pixel is a non-zero value. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

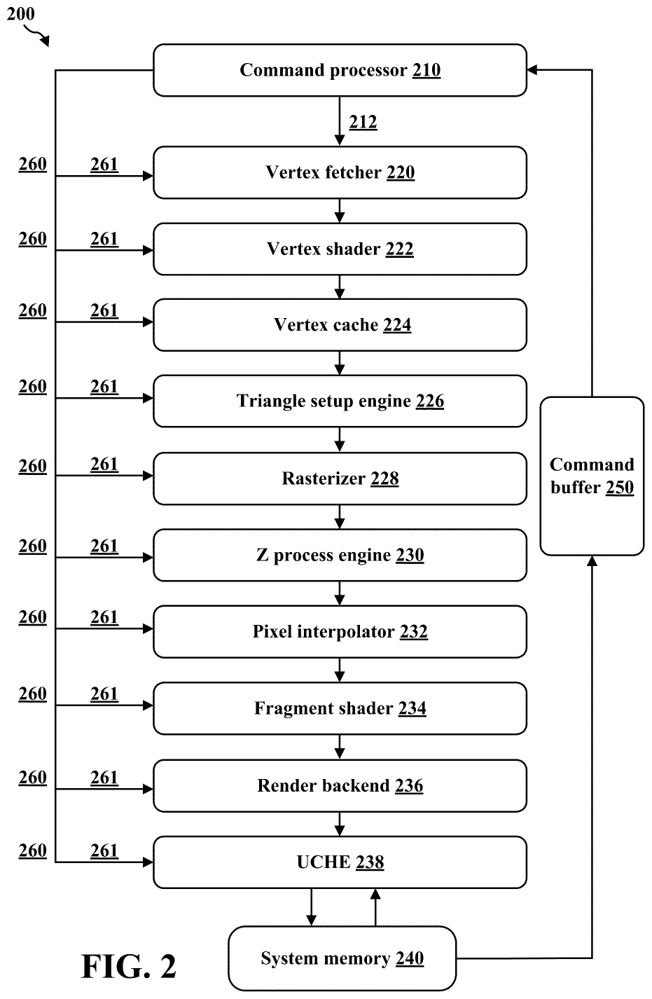

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

In some aspects of tiled rendering, there may be multiple processing phases or passes. For instance, the rendering may be performed in two passes, e.g., a visibility or bin-visibility pass and a rendering or bin-rendering pass. During a visibility pass, a GPU may input a rendering workload, record the positions of the primitives or triangles, and then determine which primitives or triangles fall into which bin or area. In some aspects of a visibility pass, GPUs may also identify or mark the visibility of each primitive or triangle in a visibility stream. During a rendering pass, a GPU may input the visibility stream and process one bin or area at a time. In some aspects, the visibility stream may be analyzed to determine which primitives, or vertices of primitives, are visible or not visible. As such, the primitives, or vertices of primitives, that are visible may be processed. By doing so, GPUs may reduce the unnecessary workload of processing or rendering primitives or triangles that are not visible. In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each of the primitives in each bin or area, e.g., in a system memory. This visibility information may be used to determine or generate a visibility stream. In a rendering pass, the primitives in each bin may be rendered separately. In these instances, the visibility stream may be fetched from memory used to drop primitives which are not visible for that bin.

Some aspects of GPUs or GPU architectures may provide a number of different options for rendering, e.g., software rendering and hardware rendering. In software rendering, a driver or CPU may replicate an entire frame geometry by processing each view one time. Additionally, some different states may be changed depending on the view. As such, in software rendering, the software may replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware may manage the replication or processing of the primitives or triangles for each viewpoint in an image.

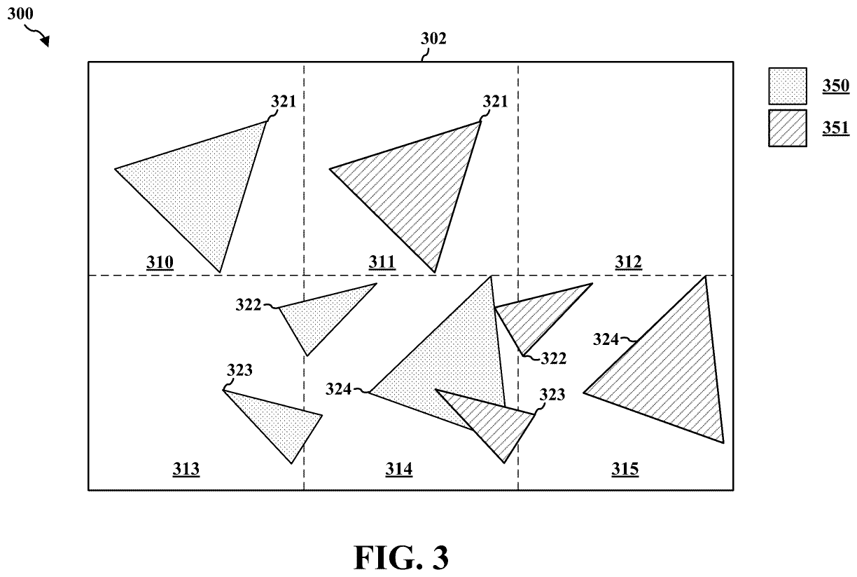

FIG. 3 illustrates image or surface 300, including multiple primitives divided into multiple bins. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 may utilize multiple viewpoints or multi-view rendering.

As indicated herein, GPUs or graphics processor units may use a tiled rendering architecture to reduce power consumption or save memory bandwidth. As further stated above, this rendering method may divide the scene into multiple bins, as well as include a visibility pass that identifies the triangles that are visible in each bin. Thus, in tiled rendering, a full screen may be divided into multiple bins or tiles. The scene may then be rendered multiple times, e.g., one or more times for each bin. In aspects of graphics rendering, some graphics applications may render to a single target, i.e., a render target, one or more times. For instance, in graphics rendering, a frame buffer on a system memory may be updated multiple times. The frame buffer may be a portion of memory or random access memory (RAM), e.g., containing a bitmap or storage, to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

In some aspects of graphics processing, rendering may be performed in multiple locations and/or on multiple devices, e.g., in order to divide the rendering workload between different devices. For example, the rendering may be split between a server and a client device, which may be referred to as “split rendering.” In some instances, split rendering may be a method for bringing content to user devices or head mounted displays (HMDs), where a portion of the graphics processing may be performed outside of the device or HMD, e.g., at a server. Split rendering may be performed for a number of different types of applications, e.g., virtual reality (VR) applications, augmented reality (AR) applications, and/or extended reality (XR) applications. In VR applications, the content displayed at the user device may correspond to man-made or animated content, e.g., content rendered at a server or user device. In AR or XR content, a portion of the content displayed at the user device may correspond to real-world content, e.g., objects in the real world, and a portion of the content may be man-made or animated content. Also, the man-made or animated content and real-world content may be displayed in an optical see-through or a video see-through device, such that the user may view real-world objects and man-made or animated content simultaneously. In some aspects, man-made or animated content may be referred to as augmented content, or vice versa.

In certain types of graphics processing, e.g., augmented reality (AR) applications, virtual reality (VR) applications, or three-dimensional (3D) games, objects may occlude (i.e., obscure, cover, block, or obstruct) other objects from the vantage point of the user device. There may also be different types of occlusions within AR/VR applications or 3D games. For example, augmented content may occlude real-world content, e.g., a rendered object may partially occlude a real object. Also, real-world content may occlude augmented content, e.g., a real object may partially occlude a rendered object. This overlap of real-world content and augmented content, which produces the aforementioned occlusions, is one reason that augmented content and real-world content may blend so seamlessly within AR. This may also result in augmented content and real-world content occlusions being difficult to resolve, such that the edges of augmented and real-world content may incorrectly overlap.

In some aspects, augmented content or augmentations may be rendered over real-world or see-through content. As such, augmentations may occlude whatever object is behind the augmentation from the vantage point of the user device. For example, pixels without an occlusion material, i.e., a red (R), green (G), blue (B) (RGB) value not equal to (0,0,0), may be rendered to occlude real-world objects. Accordingly, an augmentation with a certain value (e.g., a non-zero value) may occlude real-world objects behind the augmentation. In video see-through systems, the same effect may be achieved by compositing the augmentation layer to the foreground. As such, augmentations may occlude rendered content or real-world content, or vice versa. As indicated above, when utilizing VR/AR systems or 3D games, capturing occlusions accurately may be a challenge. Moreover, this may be especially true for VR/AR systems or 3D games with latency issues. In some aspects, it may be especially difficult to accurately capture augmented content that is occluding other augmented content, or accurately capture areal-world object that is occluding augmented content. An accurate occlusion of augmented content or real-world content and the occluded augmented content may help a user to obtain a more realistic and immersive VR/AR or 3D game experience.

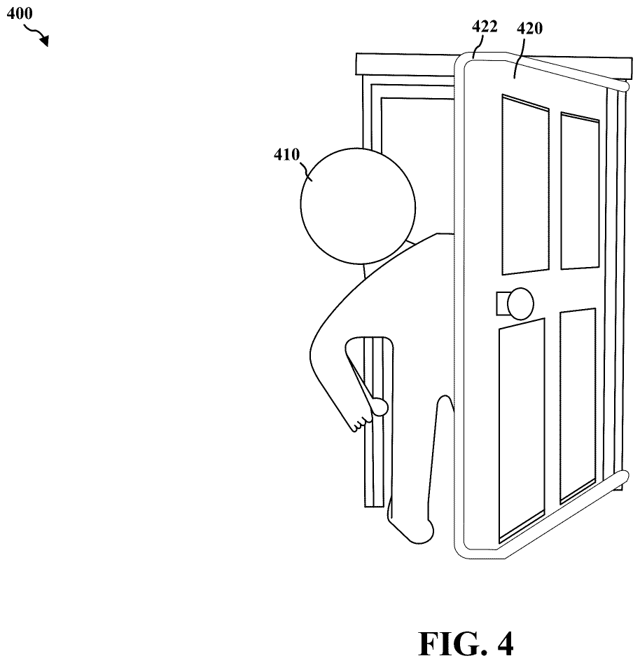

FIG. 4 illustrates diagram 400 of an example image or scene in graphics processing. Diagram 400 includes augmented content 410 and object 420 including edge 422, where object 420 may be augmented content or real-world content. More specifically, FIG. 4 displays object 420, e.g., a door, that is occluding augmented content 410, e.g., a person. Indeed, the augmented content 410 is occluded by the object 420. As indicated above, FIG. 4 displays that it may be difficult to accurately achieve the effect of certain content occluding the augmented content in an AR/VR system or 3D games. As shown in FIG. 4, AR/VR systems or 3D games may have difficultly accurately reflecting when objects occlude augmented content, or vice versa. Indeed, some AR systems or 3D games may have difficulty in quickly and accurately processing the edges of two objects when the objects are real-world content and augmented content.

Some aspects of graphics processing may utilize occlusion culling, which is a feature that disables the rendering of objects when they are not currently seen by a camera because they are obscured (i.e., occluded) by other objects. For instance, occlusion culling may remove objects in a scene from the camera rendering workload if the objects are entirely obscured by objects closer to the camera. The occlusion culling process may refer to: for a camera view in a scene, given a set of occluders (i.e., objects that are occluding other objects) and a set of occludees (i.e., objects that are being occluded by other objects), the visibility of the occludees may be derived or determined based on the relative location of the occluders. An occlusion culling calculation may refer to a calculation of the occlusion culling in a scene or image. For instance, an occlusion culling calculation may be associated with whether any pixels in a scene are not occluded by an occluding object in the scene. In some aspects, the occlusion culling process may pass through the scene using a virtual camera to build a hierarchy of potentially visible sets of objects. This data may be used by each camera in the graphics processing application to identify which objects are visible or not visible. Occlusion culling may increase rendering performance (e.g., GPU rendering performance) simply by not rendering objects that are outside the viewing area of the camera, or objects that are hidden by other objects closer to the camera. In one instance, the occlusion culling process may be defined as follows: for a camera view in a scene, given a set of occluders (i.e., objects that are occluding other objects) and a set of occludees (i.e., objects that are being occluded by other objects), the visibility of the occludees may be derived or determined based on the relative location of the occluders. For example, if a wall in a scene is closer to the camera than a set of barrels behind the wall, and there are holes in the wall, the occlusion culling process may determine which barrels are visible through the holes in the wall.

Some types of occlusion culling in graphics processing (e.g., occlusion culling for CPUs or GPUs) may include software occlusion culling. For example, in software occlusion culling, for each occluder and each primitive/triangle in a scene, the primitive/triangle may be rasterized to generate an occluder depth map. Also, for each occluder in the scene, the projected axis-aligned bounding box (AABB) area in the occluder depth map may be determined, as well as the nearest depth value of the occludee. Additionally, the occludee's nearest depth value in the projected AABB region may be determined on the occluder depth map. In a setup where closer objects have larger depth values, the occludee may be determined to be visible if its nearest depth value is larger than any depth values inside the AABB area. Otherwise, if the occludee's nearest depth value is not larger than all depth values inside the AABB area, the occludee may be determined to be invisible.

Additionally, there are other types of occlusion culling utilized in graphics processing (e.g., occlusion culling in CPUs or GPUs). For instance, there are types of software occlusion culling utilizing CPU single instruction multiple data (SIMD) components. This SIMD-optimized software occlusion culling may correspond to an optimized version of an open-source project. This type of software occlusion culling may render depth maps (e.g., an occluder depth map) more accurately and faster (e.g., 2-16 times faster) compared to other types of software occlusion culling. SIMD-optimized software occlusion culling may also be more accurate compared to GPU hardware occlusion culling (HWOC). For example, SIMD-optimized software occlusion culling may achieve zero frame latency throughout the rendering process, while GPU hardware occlusion culling may cause latency issues for at least one frame throughout the rendering process. Additionally, SIMD-optimized software occlusion culling may result in a smaller draw call amount compared to other types of software occlusion culling.

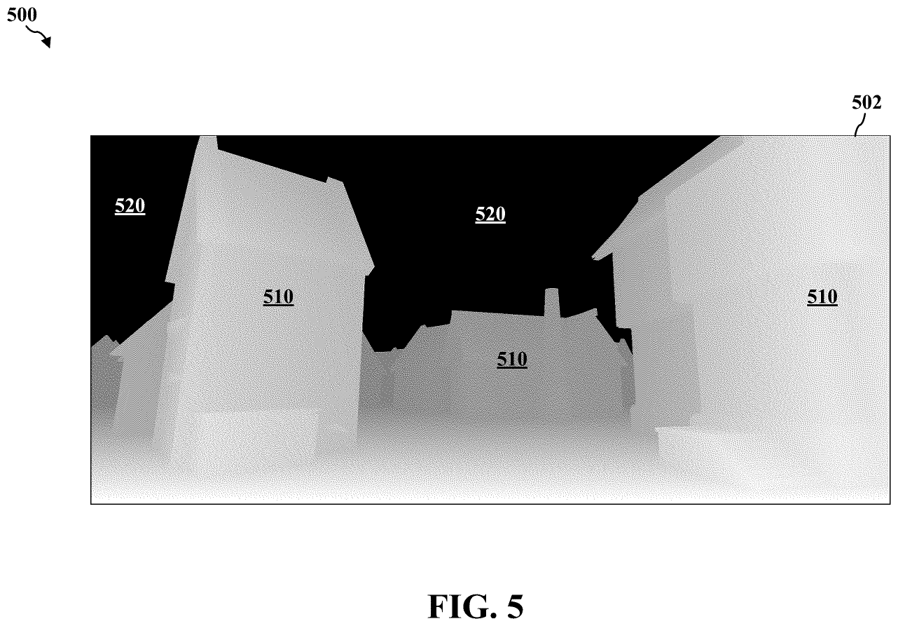

FIG. 5 illustrates diagram 500 including one example of an occluder depth map utilized in graphics processing. More specifically, diagram 500 in FIG. 5 shows an occluder depth map 502 for a scene in graphics processing. As shown in FIG. 5, diagram 500 includes occluder depth map 502 with occluded areas 510 and non-occluded areas 520. For instance, as shown in FIG. 5, the white (or light gray) areas in occluder depth map 502 are occluded areas 510, which correspond to pixels that are covered by occluding objects (e.g., houses) at a certain depth in relation to the camera. Likewise, as shown in FIG. 5, the black areas in occluder depth map 502 are non-occluded areas 520, which correspond to pixels that are not covered by the occluding objects (e.g., houses) at a certain depth in relation to the camera. Accordingly, the white color of occluded areas 510 corresponds to pixels that are covered by the houses at a certain depth, while the black color of non-occluded areas 520 corresponds to pixels that are not covered by the houses at the certain depth.

As shown in FIG. 5, different areas in occluder depth maps (e.g., occluder depth map 502) may correspond to data for different pixels. Accordingly, pixels in occluder depth maps may be associated with certain types of pixel information. For instance, pixels in occluder depth maps may include information related to whether the pixel is covered by an occluding object or occluder. For example, in FIG. 5, the occluded areas 510 may correspond to information for pixels that are covered by the houses. Additionally, pixels in occluder depth maps may include information related to the depth value of a pixel. This pixel information in the occluder depth map may correspond to the type of scene in graphics processing. Pixel information may refer to information that is associated with a pixel or a set of pixels in a scene. An occluder depth map may refer to a map of the corresponding depths of all occluders in a scene. A mask may refer to a configuration or method of hiding or filtering data. For example, when a mask is applied to data, the result is a new set of data that is a filtered version of the original data.

Some types of scenes in graphics processing may be complicated, so there may be a large number of pixels in the scene. Accordingly, as there may be a large amount of pixels in a scene, there may be a large amount of pixel information associated with occluder depth maps. The large amount of pixel information in occluder depth maps may correspond to a large amount of memory that may be needed to store the pixel information. Further, the large amount of pixel information in occluder depth maps may correspond to an extended rendering time for all the pixel information. Based on the above, it may be beneficial to reduce the amount of pixel information that is associated with occluder depth maps. Also, it may be beneficial to reduce the amount of storage space that is utilized to store pixel information associated with occluder depth maps. It may also be beneficial to reduce the amount of processing or rendering time associated with pixel information for occluder depth maps. In order to do so, it may be beneficial to utilize certain types of configurations or masks associated with occluder depth maps.

Aspects of the present disclosure may reduce the amount of pixel information that is associated with occluder depth maps. Moreover, aspects of the present disclosure may reduce the amount of storage space that is utilized to store pixel information associated with occluder depth maps. Also, aspects of the present disclosure may reduce the amount of processing or rendering time associated with pixel information for occluder depth maps. For instance, aspects of the present disclosure may utilize certain types of configurations associated with occluder depth maps. That is, aspects presented herein may utilize different mask configurations associated with occluder depth maps.

Aspects presented herein may utilize different pattern mask configurations in occluder depth maps. For instance, as occlusion culling may not need occluder depth maps to have precise pixel data for each pixel, aspects presented herein may utilize configurations or masks that do not represent every pixel. For example, aspects of the present disclosure may utilize a checkerboard mask configuration for occluder depth maps. In some aspects, when utilizing a checkerboard mask configuration, aspects presented herein may calculate the depth value for a certain amount of pixels (e.g., half of the total pixels). The depth value may refer to a value of the depth of a pixel in a frame or scene. Additionally, when utilizing a checkerboard mask configuration, for another portion of the pixels (e.g., half of the pixels), aspects presented herein may determine or derive whether a pixel is covered by an occluding object (i.e., an occluder). Further, aspects presented herein may determine whether a pixel is covered by an occluding object or occluder for all of the total pixels. Moreover, the pattern mask configurations may correspond to a visibility mask. A pattern mask configuration may refer to a configuration for a pattern mask (i.e., a mask that is associated with patterns). A visibility mask may refer to a mask for visibility data. Pixels may also be associated with coverage information in the frame or scene. Coverage information may refer to whether a pixel is occluded by an occluding object in the scene or frame.

By utilizing a pattern mask configuration (e.g., a checkerboard mask configuration), aspects presented herein may increase the amount of error calculations associated with occluder depth maps. A checkerboard mask configuration may refer to a configuration for a checkerboard mask (i.e., a mask that is associated with a checkerboard pattern). Also, in a checkerboard configuration, first pixels (e.g., black pixels) may be interleaved with second pixels (e.g., white pixels). That is, the first pixels may alternate with the second pixels in a checkerboard pattern. For instance, by utilizing checkerboard mask configurations, aspects presented herein may distribute possible errors more evenly, which may make the increased errors in occluder depth maps ignorable during an occludee query process. In some instances, when utilizing pattern mask configurations (e.g., a checkerboard mask configuration), aspects presented herein may calculate and store an amount of data (e.g., a full amount of data) associated with certain pixels (e.g., black or white pixels in the checkerboard mask configuration). The amount of data may correspond to the depth value for each of these pixels (e.g., half of the total pixels). Additionally, when utilizing pattern mask configurations (e.g., checkerboard mask configurations), aspects presented herein may calculate and store information regarding whether a pixel is covered by an occluder (e.g., whether white pixels in the checkerboard mask configuration are covered by occluder). This information regarding whether a pixel is covered by an occluder may be stored for a certain amount of pixels (e.g., half of the total pixels). In some instances, the information regarding whether a pixel is covered by an occluder may be stored for all of the pixels.

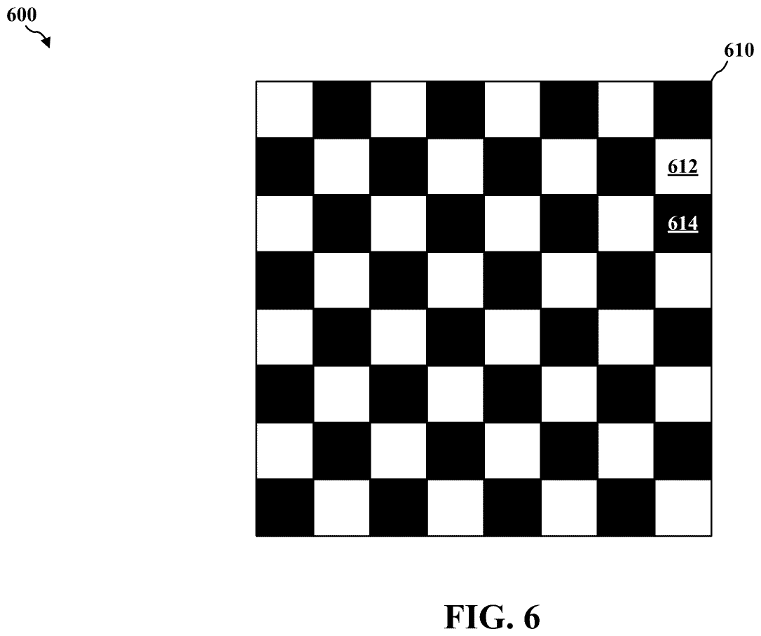

FIG. 6 illustrates diagram 600 including one example of a pattern mask configuration for graphics processing. More specifically, diagram 600 in FIG. 6 shows a checkerboard mask configuration 610 for use with occluder depth maps in graphics processing. Diagram 600 in FIG. 6 includes checkerboard mask configuration 610, a set of first pixels 612 (e.g., white pixels), and a set of second pixels 614 (e.g., black pixels). As shown in FIG. 6, the first pixels 612 may correspond to one half of the total amount of pixels and the second pixels 614 may correspond to the other half of the total amount of pixels. Aspects presented herein may calculate and store the depth value for the first pixels 612 (e.g., white pixels) or the second pixels 614 (e.g., black pixels). Additionally, aspects presented herein may calculate and store information regarding whether each of the first pixels 612 (e.g., white pixels) or the second pixels 614 (e.g., black pixels) is covered by an occluder. Aspects presented herein may also calculate and store information regarding whether all of the first pixels 612 and the second pixels 614 are covered by an occluder.

In some instances of occlusion culling, the corresponding depth value for each pixel may be stored in a memory or buffer. For example, a certain number of bits (e.g., 16 bits (2 bytes), 24 bits, or 32 bits) may be stored for the depth value of each pixel. In some aspects, the depth value for a block of pixels (e.g., a block of 8×8 pixels) may be stored at the same time. For example, for a block of 8×8 pixels (e.g., 64 pixels), in order to store the depth values for all the pixels in the block, a memory of 128 bytes (e.g., 128 bytes=8×8×2) may be needed. With the aforementioned checkerboard mask optimization, aspects presented herein may store a reduced number of bytes (e.g., 64+8=72 bytes). For example, the full data including depth values for the black pixels in the checkerboard mask configuration may equal: (8×8/2)×2=64 bytes. Also, in order to store information regarding whether certain pixels (e.g., white pixels) are covered by an occluder, aspects presented herein may store a reduced number of bits or bytes (e.g., 8×8/2=32 bits=4 bytes). In some instances, an entire block coverage mask (e.g., an 8×8 block coverage mask) may be stored, which may correspond to a certain number of bits/bytes (e.g., 8×8=64 bits=8 bytes). It may be more convenient to use the above calculation for an occludee query during an occludee AABB check.

Aspects presented herein may be flexible and calculate the depth data or pixel information for certain pixels either with or without utilizing the checkerboard mask optimization. That is, the optimization of the checkerboard mask configuration may be utilized (i.e., turned on) or not utilized (i.e., turned off). Accordingly, the checkerboard mask configuration may have on/off capability. In some instances, when the checkerboard mask configuration is off, aspects presented herein may store all of the depth data for all of the pixels, such that the coverage mask to update depth data is not utilized and not stored. In other instances, when the checkerboard mask configuration is utilized (i.e., the checkerboard mask optimization is on), aspects presented herein may store a depth value (e.g., 16 bits) for each of a first set of pixels (e.g., all of the black pixels in the checkerboard mask configuration). Additionally, when the checkerboard mask configuration is turned on, aspects presented herein may utilize a binary coverage mask for the entire image or scene. A coverage mask may refer to a mask of the pixel coverage in an image (i.e., whether a pixel is occluded by an object in the image). A binary coverage mask may refer to a coverage mask that is expressed in binary terms.

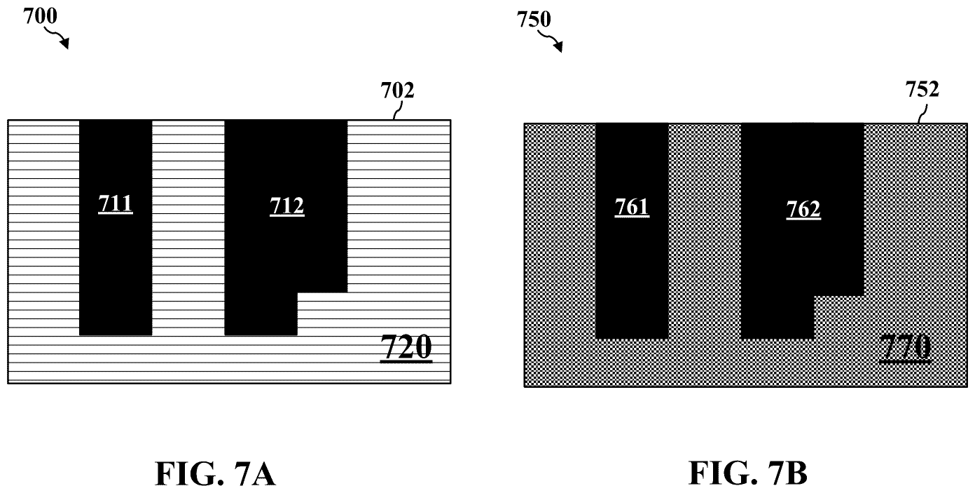

FIGS. 7A and 7B illustrate diagram 700 and diagram 750, respectively, of example occluder depth maps without a checkerboard mask configuration and with a checkerboard mask configuration. FIG. 7A illustrates diagram 700 including an occluder depth map that does not utilize a checkerboard mask configuration. More specifically, diagram 700 in FIG. 7A shows an occluder depth map 702 including non-occluded area 711 and non-occluded area 712. As shown in FIG. 7A, the black portions in the occluder depth map 702 correspond to non-occluded areas (e.g., non-occluded area 711 and non-occluded area 712) and the horizontally-striped portions correspond to occluded areas (e.g., occluded area 720). FIG. 7B illustrates diagram 750 including an occluder depth map that utilizes a checkerboard mask configuration. More specifically, diagram 750 in FIG. 7B shows an occluder depth map 752 including non-occluded area 761, non-occluded area 762, and checkerboard mask configuration 770. As shown in FIG. 7B, the black portions in the occluder depth map 752 correspond to non-occluded areas (e.g., non-occluded area 761 and non-occluded area 762) and the checkerboard portions correspond to occluded areas (i.e., the black/white checkerboard patterned areas shown covered by the checkerboard mask configuration 770). FIGS. 7A and 7B illustrate the difference between not utilizing a checkerboard mask configuration (i.e., FIG. 7A) and utilizing a checkerboard mask configuration (i.e., FIG. 7B including checkerboard mask configuration 770).

Additionally, by utilizing a checkerboard mask configuration, aspects presented herein may optimize data storage for use with occluder depth maps. For instance, when a checkerboard mask configuration is utilized, real occluder data may be stored for depth values of a block of pixels. For example, the depth data may be stored for a certain number of pixels (e.g., half of the pixels), which may correspond to the black pixels or the white pixels in the checkerboard mask configuration. Also, when the checkerboard mask configuration is utilized, real occluder data may be stored for a binary coverage mask. In some instances, certain pixels (e.g., white pixels) in the checkerboard mask configuration may correspond to the pixels covered by occluding objects or occluders. Likewise, other certain pixels (e.g., black pixels) in the checkerboard mask configuration may correspond to the pixels not being covered by occluding objects or occluders. Further, when the checkerboard mask configuration is utilized, it may have an impact on an occludee query (i.e., a query for objects that are being occluded by other objects). For instance, when the checkerboard mask configuration is utilized, it may correspond to occluded pixels having a maximum depth value (e.g., a depth values that is nearest to the camera).

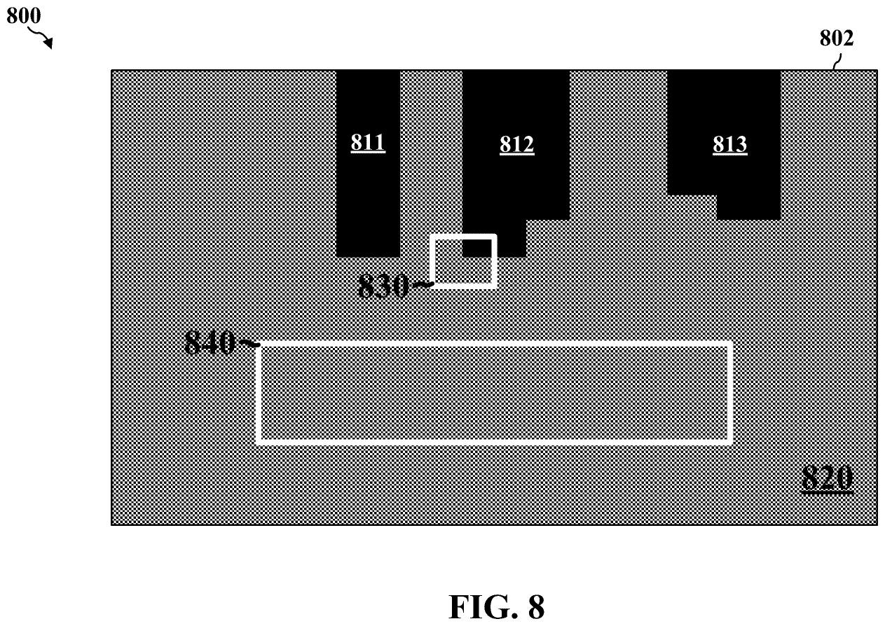

FIG. 8 illustrates diagram 800 including one example of an occluder depth map. More specifically, diagram 800 in FIG. 8 shows an occluder depth map including a checkerboard mask configuration. As shown in FIG. 8, diagram 800 includes an occluder depth map 802 including non-occluded area 811, non-occluded area 812, non-occluded area 813, and checkerboard mask configuration 820. FIG. 8 depicts that the black portions in the occluder depth map 802 correspond to non-occluded areas (e.g., non-occluded areas 811-813) and the checkerboard portions correspond to correspond to occluded areas (i.e., the black/white checkerboard patterned areas shown covered by the checkerboard mask configuration 820). Diagram 800 in FIG. 8 also includes different regions (e.g., region 830 and region 840), each of which refer to particular regions in the occluder depth map 802.

As shown in FIG. 8, region 830 is a particular area in occluder depth map 802 including both occluded areas and non-occluded area 812. Region 830 may correspond to an axis-aligned bounding box (AABB) of a projected occludee (i.e., an object that is being occluded by other objects). In occluder depth map 802, region 830 (e.g., an AABB) may contain black pixels in non-occluded area 812, which means that the occludee may be potentially visible from those black pixels in non-occluded area 812. Accordingly, the occludee in region 830 may be treated as visible during occlusion culling calculations. As such, as depicted with region 830, aspects presented herein may utilize binary coverage masks in occludee visibility queries.

As further shown in FIG. 8, region 840 is a particular area in occluder depth map 802 including occluded areas. Region 840 may also correspond to an axis-aligned bounding box (AABB) of a projected occludee. The region 840 may have a certain depth value (e.g., a depth value of 47360=185*256). However, other pixels with depth data in occluder depth map 802 may contain depth values around another depth value (e.g., a depth value of 51968=203*256). Therefore, as these depth values may be different, the occludee may be determined to be not visible. As such, as depicted with region 840, aspects presented herein may utilize depth data in occludee visibility queries.

As described herein, a checkerboard mask optimization may be utilized for occluder culling in order to reduce memory usage and improve the performance with evenly distributed error. In some aspects (e.g., 16 bits per depth configuration), this optimization may save frame buffer memory (e.g., 9/16 frame buffer memory) and time (e.g., 5˜20% total time). In some cases, this optimization may generate a same query result as a ground truth approach. Also, this optimization may generate a false culling result if an occludee occupies one pixel, as well as an occludee occupies the pixel's depth frame buffer memory and 5˜20% total time. Additionally, this optimization may generate a false culling result if an occludee occupies one pixel and the pixel's depth information is skipped. In some instances, aspects presented herein may enlarge an occludee's covered pixel region to at least two pixels in order to force a depth check.

Aspects of the present disclosure may include a number of benefits or advantages. For instance, aspects presented herein may result in an improved speed for rendering and depth rasterizations. That is, as a certain amount of pixels (e.g., half of pixels) may need to derive depth information, the checkerboard optimization may result in a faster final depth rasterization. Thus, the total occluder rendering time may be reduced by a certain percentage (e.g., reduced by 5-20% on a mobile platform). As mentioned above, the checkerboard mask optimization may introduce evenly distributed error which is less than one pixel. Occludee query results may be the same compared to the default approach. Checkerboard mask configurations may also optimize the amount of depth buffer memory that is utilized to store the pixel data. For instance, the checkerboard mask optimization described herein may reduce the depth buffer memory by a certain amount (e.g., a reduction of (128−72)/128=7/16=43.75%).

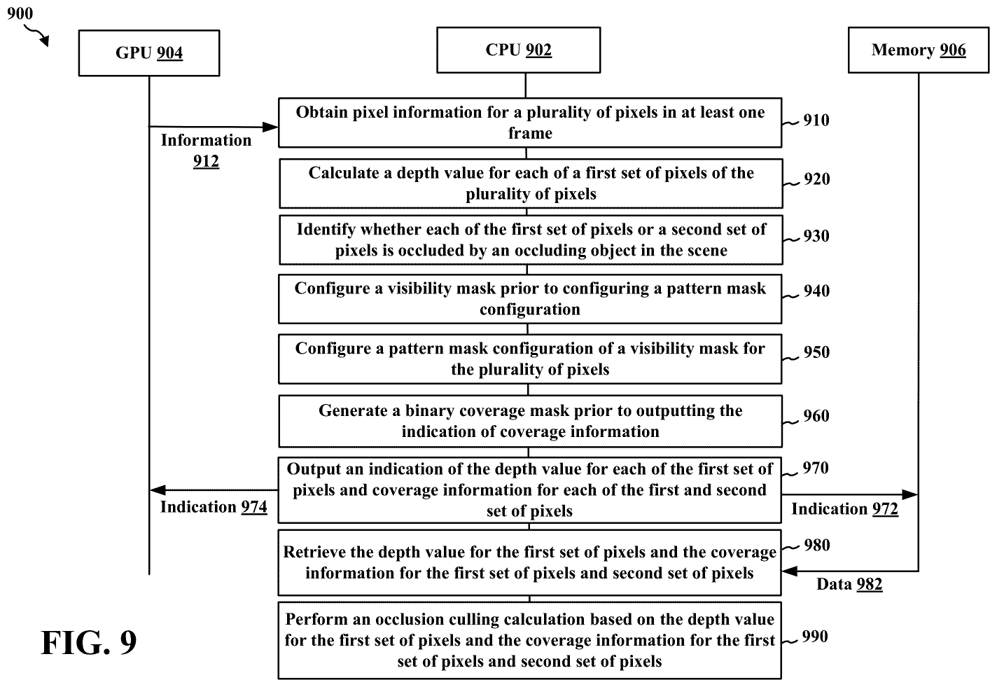

FIG. 9 is a communication flow diagram 900 of graphics processing in accordance with one or more techniques of this disclosure. As shown in FIG. 9, diagram 900 includes example communications between a CPU 902, a GPU 904, and memory 906 (e.g., system memory, double data rate (DDR) memory, or video memory), in accordance with one or more techniques of this disclosure.

At 910, CPU 902 may obtain pixel information for a plurality of pixels in at least one frame (e.g., information 912 from GPU 904), the at least one frame being included in a plurality of frames in a scene.

At 920, CPU 902 may calculate a depth value for each of a first set of pixels of the plurality of pixels. In some aspects, calculating the depth value for each of the first set of pixels may further include: calculating an amount of bits for the depth value for each of the first set of pixels.

At 930, CPU 902 may identify whether each of the first set of pixels or a second set of pixels, or both, is occluded by at least one occluding object in the scene, where the second set of pixels is included in the plurality of pixels. In some instances, each of the first set of pixels or each of the second set of pixels, or both, may be occluded by the at least one occluding object or an occluder depth if the pixel is covered by the at least one occluding object in the occluder depth map. Also, an amount of the first set of pixels may be substantially equal to half of the plurality of pixels and an amount of the second set of pixels may be substantially equal to half of the plurality of pixels, such that the amount of the first set of pixels may be substantially equal to the amount of the second set of pixels. In some aspects, substantially equal to may correspond to being within a threshold percentage of a value. For example, a first amount of pixels may be substantially equal to a second amount of pixels if the first amount of pixels is within 10% of the second amount of pixels.

At 940, CPU 902 may configure a visibility mask prior to configuring a pattern mask configuration associated with the visibility mask.

At 950, CPU 902 may configure a pattern mask configuration associated with a visibility mask for the plurality of pixels, the pattern mask configuration including a first pattern portion corresponding to the first set of pixels and a second pattern portion corresponding to the second set of pixels. In some aspects, the pattern mask configuration may be a checkerboard mask configuration (e.g., a checkerboard mask configuration including a set of odd rows, a set of even rows, a set of odd columns, and a set of even columns), and the first pattern portion may be a first checkerboard portion and the second pattern portion may be a second checkerboard portion, and where each of the first set of pixels may include a first pair of pixel coordinates in a set of pixel coordinates and each of the second set of pixels may include a second pair of pixel coordinates in the set of pixel coordinates. The first checkerboard portion may correspond to one or more first pixels (e.g., black pixels) of the checkerboard mask configuration and the second checkerboard portion may correspond to one or more second pixels (e.g., white pixels) of the checkerboard mask configuration, or where the first checkerboard portion may correspond to the one or more second pixels (e.g., white pixels) of the checkerboard mask configuration and the second checkerboard portion may correspond to the one or more first pixels (e.g., black pixels) of the checkerboard mask configuration, and where the one or more first pixels may be interleaved with the one or more second pixels, such that the one or more first pixels and the one or more second pixels may be distributed in an interleaving pattern. In some aspects, a sum of the first pair of pixel coordinates for each of the first set of pixels may be equal to an odd value, and a sum of the second pair of pixel coordinates for each of the second set of pixels may be equal to an even value. Further, a sum of the first pair of pixel coordinates for each of the first set of pixels may be equal to an even value, and a sum of the second pair of pixel coordinates for each of the second set of pixels may be equal to an odd value. In some instances, the first checkerboard portion may correspond to the set of odd rows and the set of odd columns, and the second checkerboard portion may correspond to the set of even rows and the set of even columns. Also, the first checkerboard portion may correspond to the set of even rows and the set of even columns, and the second checkerboard portion may correspond to the set of odd rows and the set of odd columns.

At 960, CPU 902 may generate a binary coverage mask prior to outputting the indication of coverage information for each of the first set of pixels and each of the second set of pixels, and where outputting the indication of coverage information for each of the first set of pixels and each of the second set of pixels may include: storing the binary coverage mask. The coverage information for each of the first set of pixels and each of the second set of pixels that is occluded by the at least one occluding object may correspond to a first value in the binary coverage mask, and the coverage information for each of the first set of pixels and each of the second set of pixels that is not occluded by the at least one occluding object may correspond to a second value in the binary coverage mask. Also, the first value in the binary coverage mask may correspond to a bit value of 1, and the second value in the binary coverage mask may correspond to a bit value of 0.

At 970, CPU 902 may output, based on the pattern mask configuration, an indication of the depth value for each of the first set of pixels and coverage information for each of the first set of pixels or the second set of pixels, or both (e.g., output indication 972 to memory 906 and/or output indication 974 to GPU 904), where the coverage information is associated with whether each of the first set of pixels or the second set of pixels, or both, is occluded by the at least one occluding object in the scene. In some instances, the coverage information for each of the first set of pixels and each of the second set of pixels may correspond to a binary coverage mask. The depth value for each of the first set of pixels and the coverage information for each of the first set of pixels or the second set of pixels, or both, may be stored in a system memory. In some aspects, outputting the indication of the depth value for each of the first set of pixels and the coverage information for each of the first set of pixels or the second set of pixels, or both, may include: storing, in a system memory, the depth value for each of the first set of pixels and the coverage information for each of the first set of pixels or the second set of pixels, or both. That is, the CPU may store, in a system memory, the depth value for each of the first set of pixels and the coverage information for each of the first set of pixels or the second set of pixels, or both. Also, in some aspects, outputting the indication of the depth value for each of the first set of pixels and the coverage information for each of the first set of pixels or the second set of pixels, or both, may include: transmitting, to at least one component of a graphics processing unit (GPU) or a central processing unit (CPU), the indication of the depth value for each of the first set of pixels and the coverage information for each of the first set of pixels or the second set of pixels, or both. That is, the CPU may transmit, to at least one component of a graphics processing unit (GPU) or a central processing unit (CPU), the indication of the depth value for each of the first set of pixels and the coverage information for each of the first set of pixels or the second set of pixels, or both. Additionally, in some aspects, outputting the indication of the depth value for each of the first set of pixels and the coverage information for each of the first set of pixels or the second set of pixels, or both, may include: outputting, via at least one of an antenna or a transceiver, the indication of the depth value for each of the first set of pixels and the coverage information for each of the first set of pixels or the second set of pixels, or both.

At 980, CPU 902 may retrieve the depth value for the first set of pixels and the coverage information for the first set of pixels and/or the second set of pixels, or both (e.g., retrieve data 982 from memory 906).

At 990, CPU 902 may perform an occlusion culling calculation based on the depth value for the first set of pixels and the coverage information for the first set of pixels and the second set of pixels, where the occlusion culling calculation is associated with whether any of the first set of pixels or any of the second set of pixels are not occluded by the at least one occluding object in the scene, where each of the first set of pixels is not occluded by the at least one occluding object if the depth value of the pixel is closer to a viewpoint (e.g., camera) of the scene than an occluding depth map value, where each of the second set of pixels is not occluded by the at least one occluding object if the coverage information of the pixel is a non-zero value.

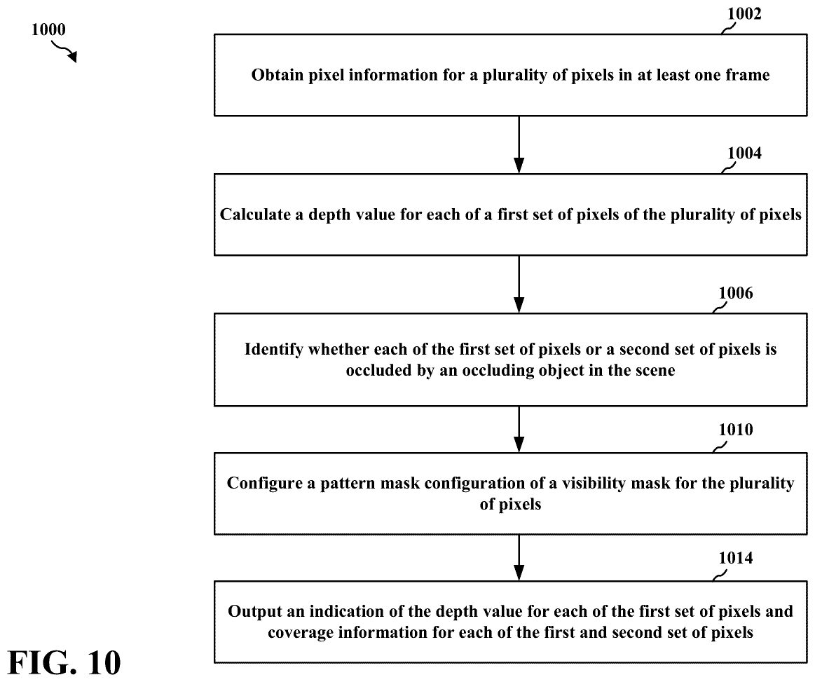

FIG. 10 is a flowchart 1000 of an example method of graphics processing in accordance with one or more techniques of this disclosure. The method may be performed by a CPU, a GPU, such as an apparatus for graphics processing, a graphics processor, a wireless communication device, and/or any apparatus that may perform graphics processing as used in connection with the examples of FIGS. 1-9. The methods described herein may provide a number of benefits, such as improving resource utilization and/or power savings.

At 1002, the CPU may obtain pixel information for a plurality of pixels in at least one frame, the at least one frame being included in a plurality of frames in a scene, as described in connection with the examples in FIGS. 1-9. For example, as described in 910 of FIG. 9, CPU 902 may obtain pixel information for a plurality of pixels in at least one frame, the at least one frame being included in a plurality of frames in a scene. Further, step 1002 may be performed by processing unit 120 in FIG. 1.

At 1004, the CPU may calculate a depth value for each of a first set of pixels of the plurality of pixels, as described in connection with the examples in FIGS. 1-9. For example, as described in 920 of FIG. 9, CPU 902 may calculate a depth value for each of a first set of pixels of the plurality of pixels. Further, step 1004 may be performed by processing unit 120 in FIG. 1. In some aspects, calculating the depth value for each of the first set of pixels may further include: calculating an amount of bits for the depth value for each of the first set of pixels.

At 1006, the CPU may identify whether each of the first set of pixels or a second set of pixels, or both, is occluded by at least one occluding object in the scene, where the second set of pixels is included in the plurality of pixels, as described in connection with the examples in FIGS. 1-9. For example, as described in 930 of FIG. 9, CPU 902 may identify whether each of the first set of pixels or a second set of pixels, or both, is occluded by at least one occluding object in the scene, where the second set of pixels is included in the plurality of pixels. Further, step 1006 may be performed by processing unit 120 in FIG. 1. In some instances, each of the first set of pixels or each of the second set of pixels, or both, may be occluded by the at least one occluding object or an occluder depth if the pixel is covered by the at least one occluding object in the occluder depth map. Also, an amount of the first set of pixels may be substantially equal to half of the plurality of pixels and an amount of the second set of pixels may be substantially equal to half of the plurality of pixels, such that the amount of the first set of pixels may be substantially equal to the amount of the second set of pixels.

At 1010, the CPU may configure a pattern mask configuration associated with a visibility mask for the plurality of pixels, the pattern mask configuration including a first pattern portion corresponding to the first set of pixels and a second pattern portion corresponding to the second set of pixels, as described in connection with the examples in FIGS. 1-9. For example, as described in 950 of FIG. 9, CPU 902 may configure a pattern mask configuration associated with a visibility mask for the plurality of pixels, the pattern mask configuration including a first pattern portion corresponding to the first set of pixels and a second pattern portion corresponding to the second set of pixels. Further, step 1010 may be performed by processing unit 120 in FIG. 1. In some aspects, the pattern mask configuration may be a checkerboard mask configuration (e.g., a checkerboard mask configuration including a set of odd rows, a set of even rows, a set of odd columns, and a set of even columns), and the first pattern portion may be a first checkerboard portion and the second pattern portion may be a second checkerboard portion, and where each of the first set of pixels may include a first pair of pixel coordinates in a set of pixel coordinates and each of the second set of pixels may include a second pair of pixel coordinates in the set of pixel coordinates. The first checkerboard portion may correspond to one or more first pixels (e.g., black pixels) of the checkerboard mask configuration and the second checkerboard portion may correspond to one or more second pixels (e.g., white pixels) of the checkerboard mask configuration, or where the first checkerboard portion may correspond to the one or more second pixels (e.g., white pixels) of the checkerboard mask configuration and the second checkerboard portion may correspond to the one or more first pixels (e.g., black pixels) of the checkerboard mask configuration, and where the one or more first pixels may be interleaved with the one or more second pixels, such that the one or more first pixels and the one or more second pixels may be distributed in an interleaving pattern. In some aspects, a sum of the first pair of pixel coordinates for each of the first set of pixels may be equal to an odd value, and a sum of the second pair of pixel coordinates for each of the second set of pixels may be equal to an even value. Further, a sum of the first pair of pixel coordinates for each of the first set of pixels may be equal to an even value, and a sum of the second pair of pixel coordinates for each of the second set of pixels may be equal to an odd value. In some instances, the first checkerboard portion may correspond to the set of odd rows and the set of odd columns, and the second checkerboard portion may correspond to the set of even rows and the set of even columns. Also, the first checkerboard portion may correspond to the set of even rows and the set of even columns, and the second checkerboard portion may correspond to the set of odd rows and the set of odd columns.

At 1014, the CPU may output, based on the pattern mask configuration, an indication of the depth value for each of the first set of pixels and coverage information for each of the first set of pixels or the second set of pixels, or both, where the coverage information is associated with whether each of the first set of pixels or the second set of pixels, or both, is occluded by the at least one occluding object in the scene, as described in connection with the examples in FIGS. 1-9. For example, as described in 970 of FIG. 9, CPU 902 may output, based on the pattern mask configuration, an indication of the depth value for each of the first set of pixels and coverage information for each of the first set of pixels or the second set of pixels, or both, where the coverage information is associated with whether each of the first set of pixels or the second set of pixels, or both, is occluded by the at least one occluding object in the scene. Further, step 1014 may be performed by processing unit 120 in FIG. 1. In some instances, the coverage information for each of the first set of pixels and each of the second set of pixels may correspond to a binary coverage mask. The depth value for each of the first set of pixels and the coverage information for each of the first set of pixels or the second set of pixels, or both, may be stored in a system memory. In some aspects, outputting the indication of the depth value for each of the first set of pixels and the coverage information for each of the first set of pixels or the second set of pixels, or both, may include: storing, in a system memory, the depth value for each of the first set of pixels and the coverage information for each of the first set of pixels or the second set of pixels, or both. That is, the CPU may store, in a system memory, the depth value for each of the first set of pixels and the coverage information for each of the first set of pixels or the second set of pixels, or both. Also, in some aspects, outputting the indication of the depth value for each of the first set of pixels and the coverage information for each of the first set of pixels or the second set of pixels, or both, may include: transmitting, to at least one component of a graphics processing unit (GPU) or a central processing unit (CPU), the indication of the depth value for each of the first set of pixels and the coverage information for each of the first set of pixels or the second set of pixels, or both. That is, the CPU may transmit, to at least one component of a graphics processing unit (GPU) or a central processing unit (CPU), the indication of the depth value for each of the first set of pixels and the coverage information for each of the first set of pixels or the second set of pixels, or both. Additionally, in some aspects, outputting the indication of the depth value for each of the first set of pixels and the coverage information for each of the first set of pixels or the second set of pixels, or both, may include: outputting, via at least one of an antenna or a transceiver, the indication of the depth value for each of the first set of pixels and the coverage information for each of the first set of pixels or the second set of pixels, or both.

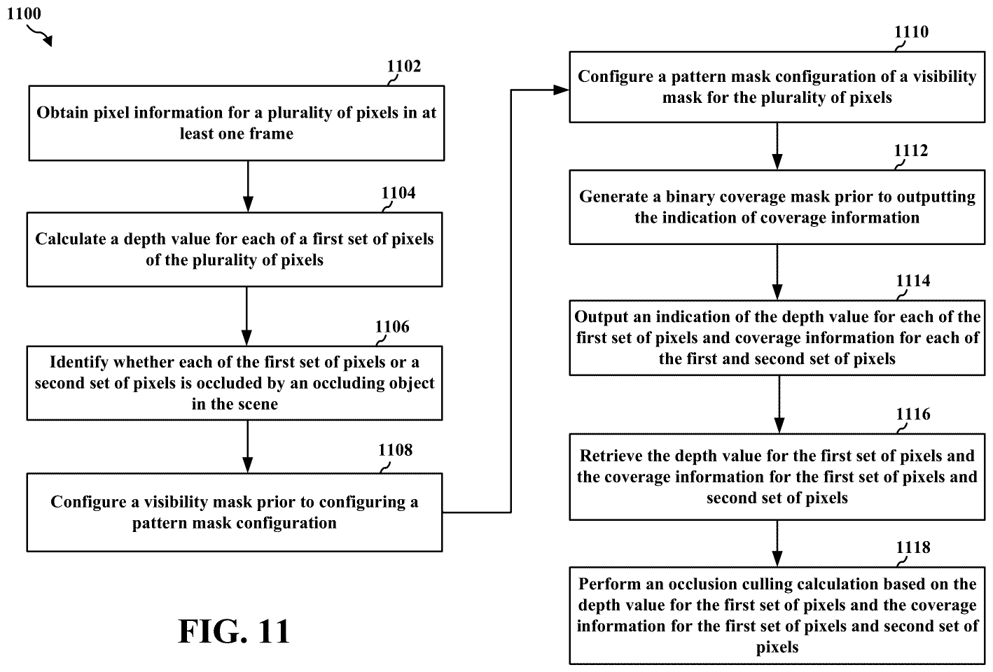

FIG. 11 is a flowchart 1100 of an example method of graphics processing in accordance with one or more techniques of this disclosure. The method may be performed by a CPU, a GPU, such as an apparatus for graphics processing, a graphics processor, a wireless communication device, and/or any apparatus that may perform graphics processing as used in connection with the examples of FIGS. 1-9. The methods described herein may provide a number of benefits, such as improving resource utilization and/or power savings.

At 1102, the CPU may obtain pixel information for a plurality of pixels in at least one frame, the at least one frame being included in a plurality of frames in a scene, as described in connection with the examples in FIGS. 1-9. For example, as described in 910 of FIG. 9, CPU 902 may obtain pixel information for a plurality of pixels in at least one frame, the at least one frame being included in a plurality of frames in a scene. Further, step 1102 may be performed by processing unit 120 in FIG. 1.

At 1104, the CPU may calculate a depth value for each of a first set of pixels of the plurality of pixels, as described in connection with the examples in FIGS. 1-9. For example, as described in 920 of FIG. 9, CPU 902 may calculate a depth value for each of a first set of pixels of the plurality of pixels. Further, step 1104 may be performed by processing unit 120 in FIG. 1. In some aspects, calculating the depth value for each of the first set of pixels may further include: calculating an amount of bits for the depth value for each of the first set of pixels.

At 1106, the CPU may identify whether each of the first set of pixels or a second set of pixels, or both, is occluded by at least one occluding object in the scene, where the second set of pixels is included in the plurality of pixels, as described in connection with the examples in FIGS. 1-9. For example, as described in 930 of FIG. 9, CPU 902 may identify whether each of the first set of pixels or a second set of pixels, or both, is occluded by at least one occluding object in the scene, where the second set of pixels is included in the plurality of pixels. Further, step 1106 may be performed by processing unit 120 in FIG. 1. In some instances, each of the first set of pixels or each of the second set of pixels, or both, may be occluded by the at least one occluding object or an occluder depth if the pixel is covered by the at least one occluding object in the occluder depth map. Also, an amount of the first set of pixels may be substantially equal to half of the plurality of pixels and an amount of the second set of pixels may be substantially equal to half of the plurality of pixels, such that the amount of the first set of pixels may be substantially equal to the amount of the second set of pixels.

At 1108, the CPU may configure a visibility mask prior to configuring a pattern mask configuration associated with the visibility mask, as described in connection with the examples in FIGS. 1-9. For example, as described in 940 of FIG. 9, CPU 902 may configure a visibility mask prior to configuring a pattern mask configuration associated with the visibility mask. Further, step 1108 may be performed by processing unit 120 in FIG. 1.

At 1110, the CPU may configure a pattern mask configuration associated with a visibility mask for the plurality of pixels, the pattern mask configuration including a first pattern portion corresponding to the first set of pixels and a second pattern portion corresponding to the second set of pixels, as described in connection with the examples in FIGS. 1-9. For example, as described in 950 of FIG. 9, CPU 902 may configure a pattern mask configuration associated with a visibility mask for the plurality of pixels, the pattern mask configuration including a first pattern portion corresponding to the first set of pixels and a second pattern portion corresponding to the second set of pixels. Further, step 1110 may be performed by processing unit 120 in FIG. 1. In some aspects, the pattern mask configuration may be a checkerboard mask configuration (e.g., a checkerboard mask configuration including a set of odd rows, a set of even rows, a set of odd columns, and a set of even columns), and the first pattern portion may be a first checkerboard portion and the second pattern portion may be a second checkerboard portion, and where each of the first set of pixels may include a first pair of pixel coordinates in a set of pixel coordinates and each of the second set of pixels may include a second pair of pixel coordinates in the set of pixel coordinates. The first checkerboard portion may correspond to one or more first pixels (e.g., black pixels) of the checkerboard mask configuration and the second checkerboard portion may correspond to one or more second pixels (e.g., white pixels) of the checkerboard mask configuration, or the first checkerboard portion may correspond to the one or more second pixels (e.g., white pixels) of the checkerboard mask configuration and the second checkerboard portion may correspond to the one or more first pixels (e.g., black pixels) of the checkerboard mask configuration, and where the one or more first pixels may be interleaved with the one or more second pixels, such that the one or more first pixels and the one or more second pixels may be distributed in an interleaving pattern. In some aspects, a sum of the first pair of pixel coordinates for each of the first set of pixels may be equal to an odd value, and a sum of the second pair of pixel coordinates for each of the second set of pixels may be equal to an even value. Further, a sum of the first pair of pixel coordinates for each of the first set of pixels may be equal to an even value, and a sum of the second pair of pixel coordinates for each of the second set of pixels may be equal to an odd value. In some instances, the first checkerboard portion may correspond to the set of odd rows and the set of odd columns, and the second checkerboard portion may correspond to the set of even rows and the set of even columns. Also, the first checkerboard portion may correspond to the set of even rows and the set of even columns, and the second checkerboard portion may correspond to the set of odd rows and the set of odd columns.

At 1112, the CPU may generate a binary coverage mask prior to outputting the indication of coverage information for each of the first set of pixels and each of the second set of pixels, and where outputting the indication of coverage information for each of the first set of pixels and each of the second set of pixels may include: storing the binary coverage mask, as described in connection with the examples in FIGS. 1-9. For example, as described in 960 of FIG. 9, CPU 902 may generate a binary coverage mask prior to storing coverage information for each of the first set of pixels or the second set of pixels, or both, and where storing coverage information for each of the first set of pixels or the second set of pixels, or both, may include: storing the binary coverage mask. Further, step 1112 may be performed by processing unit 120 in FIG. 1. The coverage information for each of the first set of pixels and each of the second set of pixels that is occluded by the at least one occluding object may correspond to a first value in the binary coverage mask, and the coverage information for each of the first set of pixels and each of the second set of pixels that is not occluded by the at least one occluding object may correspond to a second value in the binary coverage mask. Also, the first value in the binary coverage mask may correspond to a bit value of 1, and the second value in the binary coverage mask may correspond to a bit value of 0.

At 1114, the CPU may output, based on the pattern mask configuration, an indication of the depth value for each of the first set of pixels and coverage information for each of the first set of pixels or the second set of pixels, or both, where the coverage information is associated with whether each of the first set of pixels or the second set of pixels, or both, is occluded by the at least one occluding object in the scene, as described in connection with the examples in FIGS. 1-9. For example, as described in 970 of FIG. 9, CPU 902 may output, based on the pattern mask configuration, an indication of the depth value for each of the first set of pixels and coverage information for each of the first set of pixels or the second set of pixels, or both, where the coverage information is associated with whether each of the first set of pixels or the second set of pixels, or both, is occluded by the at least one occluding object in the scene. Further, step 1114 may be performed by processing unit 120 in FIG. 1. In some instances, the coverage information for each of the first set of pixels and each of the second set of pixels may correspond to a binary coverage mask. The depth value for each of the first set of pixels and the coverage information for each of the first set of pixels or the second set of pixels, or both, may be stored in a system memory. In some aspects, outputting the indication of the depth value for each of the first set of pixels and the coverage information for each of the first set of pixels or the second set of pixels, or both, may include: storing, in a system memory, the depth value for each of the first set of pixels and the coverage information for each of the first set of pixels or the second set of pixels, or both. That is, the CPU may store, in a system memory, the depth value for each of the first set of pixels and the coverage information for each of the first set of pixels or the second set of pixels, or both. Also, in some aspects, outputting the indication of the depth value for each of the first set of pixels and the coverage information for each of the first set of pixels or the second set of pixels, or both, may include: transmitting, to at least one component of a graphics processing unit (GPU) or a central processing unit (CPU), the indication of the depth value for each of the first set of pixels and the coverage information for each of the first set of pixels or the second set of pixels, or both. That is, the CPU may transmit, to at least one component of a graphics processing unit (GPU) or a central processing unit (CPU), the indication of the depth value for each of the first set of pixels and the coverage information for each of the first set of pixels or the second set of pixels, or both. Additionally, in some aspects, outputting the indication of the depth value for each of the first set of pixels and the coverage information for each of the first set of pixels or the second set of pixels, or both, may include: outputting, via at least one of an antenna or a transceiver, the indication of the depth value for each of the first set of pixels and the coverage information for each of the first set of pixels or the second set of pixels, or both.

At 1116, the CPU may retrieve the depth value for the first set of pixels and the coverage information for the first set of pixels and/or the second set of pixels, or both, as described in connection with the examples in FIGS. 1-9. For example, as described in 980 of FIG. 9, CPU 902 may retrieve the depth value for each of the first set of pixels and the coverage information for each of the first set of pixels or the second set of pixels, or both. Further, step 1116 may be performed by processing unit 120 in FIG. 1.

At 1118, the CPU may perform an occlusion culling calculation based on the depth value for the first set of pixels and the coverage information for the first set of pixels and the second set of pixels, where the occlusion culling calculation is associated with whether any of the first set of pixels or any of the second set of pixels are not occluded by the at least one occluding object in the scene, where each of the first set of pixels is not occluded by the at least one occluding object if the depth value of the pixel is closer to a viewpoint of the scene than an occluding depth map value, where each of the second set of pixels is not occluded by the at least one occluding object if the coverage information of the pixel is a non-zero value, as described in connection with the examples in FIGS. 1-9. For example, as described in 990 of FIG. 9, CPU 902 may perform an occlusion culling calculation based on the depth value for the first set of pixels and the coverage information for the first set of pixels and the second set of pixels, where the occlusion culling calculation is associated with whether any of the first set of pixels or any of the second set of pixels are not occluded by the at least one occluding object in the scene, where each of the first set of pixels is not occluded by the at least one occluding object if the depth value of the pixel is closer to a viewpoint of the scene than an occluding depth map value, where each of the second set of pixels is not occluded by the at least one occluding object if the coverage information of the pixel is a non-zero value. Further, step 1118 may be performed by processing unit 120 in FIG. 1.

In configurations, a method or an apparatus for graphics processing is provided. The apparatus may be a CPU, a GPU, a graphics processor, or some other processor that may perform graphics processing. In aspects, the apparatus may be the processing unit 120 within the device 104, or may be some other hardware within the device 104 or another device. The apparatus, e.g., processing unit 120, may include means for obtaining pixel information for a plurality of pixels in at least one frame, the at least one frame being included in a plurality of frames in a scene. The apparatus, e.g., processing unit 120, may also include means for calculating a depth value for each of a first set of pixels of the plurality of pixels. The apparatus, e.g., processing unit 120, may also include means for identifying whether each of the first set of pixels or a second set of pixels, or both, is occluded by at least one occluding object in the scene, where the second set of pixels is included in the plurality of pixels. The apparatus, e.g., processing unit 120, may also include means for configuring a pattern mask configuration associated with a visibility mask for the plurality of pixels, the pattern mask configuration including a first pattern portion corresponding to the first set of pixels and a second pattern portion corresponding to the second set of pixels. The apparatus, e.g., processing unit 120, may also include means for outputting, based on the pattern mask configuration, an indication of the depth value for each of the first set of pixels and coverage information for each of the first set of pixels or the second set of pixels, or both, where the coverage information is associated with whether each of the first set of pixels or the second set of pixels, or both, is occluded by the at least one occluding object in the scene. The apparatus, e.g., processing unit 120, may also include means for generating the binary coverage mask prior to storing the coverage information for each of the first set of pixels or the second set of pixels, or both, and where storing the coverage information for each of the first set of pixels or the second set of pixels, or both, includes: storing the binary coverage mask; means for retrieving the depth value for each of the first set of pixels and the coverage information for each of the first set of pixels or the second set of pixels, or both. The apparatus, e.g., processing unit 120, may also include means for performing an occlusion culling calculation based on the depth value for each of the first set of pixels and the coverage information for each of the first set of pixels or the second set of pixels, or both, where the occlusion culling calculation is associated with whether each of the first set of pixels or the second set of pixels, or both, is occluded by the at least one occluding object in the scene. The apparatus, e.g., processing unit 120, may also include means for configuring the visibility mask prior to configuring the pattern mask configuration associated with the visibility mask.

The subject matter described herein may be implemented to realize one or more benefits or advantages. For instance, the described graphics processing techniques may be used by a CPU, a GPU, a graphics processor, or some other processor that may perform graphics processing to implement the checkerboard mask optimization techniques described herein. This may also be accomplished at a low cost compared to other graphics processing techniques. Moreover, the graphics processing techniques herein may improve or speed up data processing or execution. Further, the graphics processing techniques herein may improve resource or data utilization and/or resource efficiency. Additionally, aspects of the present disclosure may utilize checkerboard mask optimization techniques in order to improve memory bandwidth efficiency and/or increase processing speed at a CPU or GPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing including at least one processor coupled to a memory and, based at least in part on first information stored in the memory, the at least one processor is configured to: obtain pixel information for a plurality of pixels in at least one frame, the at least one frame being included in a plurality of frames in a scene; calculate a depth value for each of a first set of pixels of the plurality of pixels; identify whether each of the first set of pixels or a second set of pixels, or both, is occluded by at least one occluding object in the scene, where the second set of pixels is included in the plurality of pixels; configure a pattern mask configuration associated with a visibility mask for the plurality of pixels, the pattern mask configuration including a first pattern portion corresponding to the first set of pixels and a second pattern portion corresponding to the second set of pixels; and output, based on the pattern mask configuration, an indication of the depth value for each of the first set of pixels and coverage information for each of the first set of pixels or the second set of pixels, or both, where the coverage information is associated with whether each of the first set of pixels or the second set of pixels, or both, is occluded by the at least one occluding object in the scene.

Aspect 2 is the apparatus of aspect 1, where the pattern mask configuration is a checkerboard mask configuration, where the first pattern portion is a first checkerboard portion and the second pattern portion is a second checkerboard portion, and where each of the first set of pixels includes a first pair of pixel coordinates in a set of pixel coordinates and each of the second set of pixels includes a second pair of pixel coordinates in the set of pixel coordinates.

Aspect 3 is the apparatus of aspect 2, where the first checkerboard portion corresponds to one or more first pixels of the checkerboard mask configuration and the second checkerboard portion corresponds to one or more second pixels of the checkerboard mask configuration or where the first checkerboard portion corresponds to the one or more second pixels of the checkerboard mask configuration and the second checkerboard portion corresponds to the one or more first pixels of the checkerboard mask configuration, and where the one or more first pixels are interleaved with the one or more second pixels, such that the one or more first pixels and the one or more second pixels are distributed in an interleaving pattern.

Aspect 4 is the apparatus of any of aspects 2 to 3, where a sum of the first pair of pixel coordinates for each of the first set of pixels is equal to an odd value, and where a sum of the second pair of pixel coordinates for each of the second set of pixels is equal to an even value.

Aspect 5 is the apparatus of any of aspects 2 to 4, where a sum of the first pair of pixel coordinates for each of the first set of pixels is equal to an even value, and where a sum of the second pair of pixel coordinates for each of the second set of pixels is equal to an odd value.

Aspect 6 is the apparatus of any of aspects 1 to 5, where the coverage information for each of the first set of pixels and each of the second set of pixels corresponds to a binary coverage mask.

Aspect 7 is the apparatus of aspect 6, where the at least one processor is further configured to: generate the binary coverage mask prior to the output of the indication of the coverage information for each of the first set of pixels and each of the second set of pixels, and where to output the indication of the coverage information for each of the first set of pixels and each of the second set of pixels, the at least one processor is configured to: store the binary coverage mask.

Aspect 8 is the apparatus of any of aspects 6 to 7, where the coverage information for each of the first set of pixels and each of the second set of pixels that is occluded by the at least one occluding object corresponds to a first value in the binary coverage mask, and the coverage information for each of the first set of pixels and each of the second set of pixels that is not occluded by the at least one occluding object corresponds to a second value in the binary coverage mask.

Aspect 9 is the apparatus of any of aspects 6 to 8, where the first value in the binary coverage mask corresponds to a bit value of 1, and the second value in the binary coverage mask corresponds to a bit value of 0.

Aspect 10 is the apparatus of any of aspects 1 to 9, where the at least one processor is further configured to: retrieve the depth value for the first set of pixels and the coverage information for the first set of pixels and the second set of pixels.

Aspect 11 is the apparatus of aspect 10, where the at least one processor is further configured to: perform an occlusion culling calculation based on the depth value for the first set of pixels and the coverage information for the first set of pixels and the second set of pixels, where the occlusion culling calculation is associated with whether any of the first set of pixels or any of the second set of pixels are not occluded by the at least one occluding object in the scene, where each of the first set of pixels is not occluded by the at least one occluding object if the depth value of the pixel is closer to a viewpoint of the scene than an occluding depth map value, where each of the second set of pixels is not occluded by the at least one occluding object if the coverage information of the pixel is a non-zero value.

Aspect 12 is the apparatus of any of aspects 1 to 11, where each of the first set of pixels or each of the second set of pixels, or both, is occluded by the at least one occluding object or an occluder depth map if the pixel is covered by the at least one occluding object in the occluder depth map.

Aspect 13 is the apparatus of any of aspects 1 to 12, where the at least one processor is further configured to: configure the visibility mask prior to the configuration of the pattern mask configuration associated with the visibility mask.

Aspect 14 is the apparatus of any of aspects 1 to 13, where an amount of the first set of pixels is substantially equal to half of the plurality of pixels and an amount of the second set of pixels is substantially equal to half of the plurality of pixels, such that the amount of the first set of pixels is substantially equal to the amount of the second set of pixels.

Aspect 15 is the apparatus of any of aspects 1 to 14, where to calculate the depth value for each of the first set of pixels, the at least one processor is configured to: calculate an amount of bits for the depth value for each of the first set of pixels.

Aspect 16 is the apparatus of any of aspects 1 to 15, where to output the indication of the depth value for each of the first set of pixels and the coverage information for each of the first set of pixels or the second set of pixels, or both, the at least one processor is configured to: store, in a system memory, the depth value for each of the first set of pixels and the coverage information for each of the first set of pixels or the second set of pixels, or both.

Aspect 17 is the apparatus of any of aspects 1 to 16, where to output the indication of the depth value for each of the first set of pixels and the coverage information for each of the first set of pixels or the second set of pixels, or both, the at least one processor is configured to: transmit, to at least one component of a graphics processing unit (GPU) or a central processing unit (CPU), the indication of the depth value for each of the first set of pixels and the coverage information for each of the first set of pixels or the second set of pixels, or both.

Aspect 18 is the apparatus of any of aspects 1 to 17, where the apparatus is a wireless communication device, further including at least one of an antenna or a transceiver coupled to the at least one processor, where to output the indication of the depth value for each of the first set of pixels and the coverage information for each of the first set of pixels or the second set of pixels, or both, the at least one processor is configured to: output, via at least one of the antenna or the transceiver, the indication of the depth value for each of the first set of pixels and the coverage information for each of the first set of pixels or the second set of pixels, or both.

Aspect 19 is a method of graphics processing for implementing any of aspects 1 to 18.

Aspect 20 is an apparatus for graphics processing including means for implementing any of aspects 1 to 18.

Aspect 21 is a computer-readable medium (e.g., a non-transitory computer-readable medium) storing computer executable code, the code when executed by at least one processor causes the at least one processor to implement any of aspects 1 to 18.

What is claimed is:

1. An apparatus for graphics processing, comprising:
a memory; and
at least one processor coupled to the memory and, based at least in part on first information stored in the memory, the at least one processor is configured to:
obtain pixel information for a plurality of pixels in at least one frame, the at least one frame being included in a plurality of frames in a scene;
calculate a depth value for each of a first set of pixels of the plurality of pixels;
identify whether each of the first set of pixels or a second set of pixels, or both, is occluded by at least one occluding object in the scene, wherein the second set of pixels is included in the plurality of pixels;
configure a pattern mask configuration associated with a visibility mask for the plurality of pixels, the pattern mask configuration including a first pattern portion corresponding to the first set of pixels and a second pattern portion corresponding to the second set of pixels; and
output, based on the pattern mask configuration, an indication of the depth value for each of the first set of pixels and coverage information for each of the first set of pixels or the second set of pixels, or both, wherein the coverage information is associated with whether each of the first set of pixels or the second set of pixels, or both, is occluded by the at least one occluding object in the scene.

2. The apparatus of claim 1, wherein the pattern mask configuration is a checkerboard mask configuration, wherein the first pattern portion is a first checkerboard portion and the second pattern portion is a second checkerboard portion, and wherein each of the first set of pixels includes a first pair of pixel coordinates in a set of pixel coordinates and each of the second set of pixels includes a second pair of pixel coordinates in the set of pixel coordinates.

3. The apparatus of claim 2, wherein the first checkerboard portion corresponds to one or more first pixels of the checkerboard mask configuration and the second checkerboard portion corresponds to one or more second pixels of the checkerboard mask configuration or wherein the first checkerboard portion corresponds to the one or more second pixels of the checkerboard mask configuration and the second checkerboard portion corresponds to the one or more first pixels of the checkerboard mask configuration, and wherein the one or more first pixels are interleaved with the one or more second pixels, such that the one or more first pixels and the one or more second pixels are distributed in an interleaving pattern.

4. The apparatus of claim 2, wherein a sum of the first pair of pixel coordinates for each of the first set of pixels is equal to an odd value, and wherein a sum of the second pair of pixel coordinates for each of the second set of pixels is equal to an even value.

5. The apparatus of claim 2, wherein a sum of the first pair of pixel coordinates for each of the first set of pixels is equal to an even value, and wherein a sum of the second pair of pixel coordinates for each of the second set of pixels is equal to an odd value.

6. The apparatus of claim 1, wherein the coverage information for each of the first set of pixels and each of the second set of pixels corresponds to a binary coverage mask.

7. The apparatus of claim 6, wherein the at least one processor is further configured to:
generate the binary coverage mask prior to the output of the indication of the coverage information for each of the first set of pixels and each of the second set of pixels, and wherein to output the indication of the coverage information for each of the first set of pixels and each of the second set of pixels, the at least one processor is configured to: store the binary coverage mask.

8. The apparatus of claim 6, wherein the coverage information for each of the first set of pixels and each of the second set of pixels that is occluded by the at least one occluding object corresponds to a first value in the binary coverage mask, and the coverage information for each of the first set of pixels and each of the second set of pixels that is not occluded by the at least one occluding object corresponds to a second value in the binary coverage mask.

9. The apparatus of claim 8, wherein the first value in the binary coverage mask corresponds to a bit value of 1, and the second value in the binary coverage mask corresponds to a bit value of 0.

10. The apparatus of claim 1, wherein the at least one processor is further configured to:
retrieve the depth value for the first set of pixels and the coverage information for the first set of pixels and the second set of pixels.

11. The apparatus of claim 10, wherein the at least one processor is further configured to:
perform an occlusion culling calculation based on the depth value for the first set of pixels and the coverage information for the first set of pixels and the second set of pixels, wherein the occlusion culling calculation is associated with whether any of the first set of pixels or any of the second set of pixels are not occluded by the at least one occluding object in the scene, wherein each of the first set of pixels is not occluded by the at least one occluding object if the depth value of the pixel is closer to a viewpoint of the scene than an occluding depth map value, wherein each of the second set of pixels is not occluded by the at least one occluding object if the coverage information of the pixel is a non-zero value.

12. The apparatus of claim 1, wherein each of the first set of pixels or each of the second set of pixels, or both, is occluded by the at least one occluding object or an occluder depth map if the pixel is covered by the at least one occluding object in the occluder depth map.

13. The apparatus of claim 1, wherein the at least one processor is further configured to:
configure the visibility mask prior to the configuration of the pattern mask configuration associated with the visibility mask.

14. The apparatus of claim 1, wherein an amount of the first set of pixels is substantially equal to half of the plurality of pixels and an amount of the second set of pixels is substantially equal to half of the plurality of pixels, such that the amount of the first set of pixels is substantially equal to the amount of the second set of pixels.

15. The apparatus of claim 1, wherein to calculate the depth value for each of the first set of pixels, the at least one processor is configured to: calculate an amount of bits for the depth value for each of the first set of pixels.

16. The apparatus of claim 1, wherein to output the indication of the depth value for each of the first set of pixels and the coverage information for each of the first set of pixels or the second set of pixels, or both, the at least one processor is configured to: store, in a system memory, the depth value for each of the first set of pixels and the coverage information for each of the first set of pixels or the second set of pixels, or both.

17. The apparatus of claim 1, wherein to output the indication of the depth value for each of the first set of pixels and the coverage information for each of the first set of pixels or the second set of pixels, or both, the at least one processor is configured to: transmit, to at least one component of a graphics processing unit (GPU) or a central processing unit (CPU), the indication of the depth value for each of the first set of pixels and the coverage information for each of the first set of pixels or the second set of pixels, or both.

18. The apparatus of claim 1, wherein the apparatus is a wireless communication device, further comprising at least one of an antenna or a transceiver coupled to the at least one processor, wherein to output the indication of the depth value for each of the first set of pixels and the coverage information for each of the first set of pixels or the second set of pixels, or both, the at least one processor is configured to: output, via at least one of the antenna or the transceiver, the indication of the depth value for each of the first set of pixels and the coverage information for each of the first set of pixels or the second set of pixels, or both.

19. A method of graphics processing, comprising:
obtaining pixel information for a plurality of pixels in at least one frame, the at least one frame being included in a plurality of frames in a scene;
calculating a depth value for each of a first set of pixels of the plurality of pixels;
identifying whether each of the first set of pixels or a second set of pixels, or both, is occluded by at least one occluding object in the scene, wherein the second set of pixels is included in the plurality of pixels;
configuring a pattern mask configuration associated with a visibility mask for the plurality of pixels, the pattern mask configuration including a first pattern portion corresponding to the first set of pixels and a second pattern portion corresponding to the second set of pixels; and
outputting, based on the pattern mask configuration, an indication of the depth value for each of the first set of pixels and coverage information for each of the first set of pixels or the second set of pixels, or both, wherein the coverage information is associated with whether each of the first set of pixels or the second set of pixels, or both, is occluded by the at least one occluding object in the scene.

20. The method of claim 19, wherein the pattern mask configuration is a checkerboard mask configuration, wherein the first pattern portion is a first checkerboard portion and the second pattern portion is a second checkerboard portion, and wherein each of the first set of pixels includes a first pair of pixel coordinates in a set of pixel coordinates and each of the second set of pixels includes a second pair of pixel coordinates in the set of pixel coordinates.

21. The method of claim 20, wherein the first checkerboard portion corresponds to one or more first pixels of the checkerboard mask configuration and the second checkerboard portion corresponds to one or more second pixels of the checkerboard mask configuration or wherein the first checkerboard portion corresponds to the one or more second pixels of the checkerboard mask configuration and the second checkerboard portion corresponds to the one or more first pixels of the checkerboard mask configuration, and wherein the one or more first pixels are interleaved with the one or more second pixels, such that the one or more first pixels and the one or more second pixels are distributed in an interleaving pattern.

22. The method of claim 20, wherein a sum of the first pair of pixel coordinates for each of the first set of pixels is equal to a first odd value and a sum of the second pair of pixel coordinates for each of the second set of pixels is equal to a first even value; or wherein a sum of the first pair of pixel coordinates for each of the first set of pixels is equal to a second even value and a sum of the second pair of pixel coordinates for each of the second set of pixels is equal to a second odd value.

23. The method of claim 19, wherein the coverage information for each of the first set of pixels and each of the second set of pixels corresponds to a binary coverage mask.

24. The method of claim 23, further comprising:
generating the binary coverage mask prior to outputting the indication of the coverage information for each of the first set of pixels and each of the second set of pixels, and wherein outputting the indication of the coverage information for each of the first set of pixels and each of the second set of pixels comprises: storing the binary coverage mask.

25. The method of claim 23, wherein the coverage information for each of the first set of pixels and each of the second set of pixels that is occluded by the at least one occluding object corresponds to a first value in the binary coverage mask, and the coverage information for each of the first set of pixels and each of the second set of pixels that is not occluded by the at least one occluding object corresponds to a second value in the binary coverage mask, and wherein the first value in the binary coverage mask corresponds to a bit value of 1, and the second value in the binary coverage mask corresponds to a bit value of 0.

26. The method of claim 19, further comprising:
retrieving the depth value for the first set of pixels and the coverage information for the first set of pixels and the second set of pixels; and
performing an occlusion culling calculation based on the depth value for each of the first set of pixels and the coverage information for the first set of pixels and the second set of pixels, wherein the occlusion culling calculation is associated with whether any of the first set of pixels or any of the second set of pixels are not occluded by the at least one occluding object in the scene, wherein each of the first set of pixels is not occluded by the at least one occluding object if the depth value of the pixel is closer to a viewpoint of the scene than an occluding depth map value, wherein each of the second set of pixels is not occluded by the at least one occluding object if the coverage information of the pixel is a non-zero value.

27. The method of claim 19, wherein each of the first set of pixels or each of the second set of pixels, or both, is occluded by the at least one occluding object or an occluder depth map if the pixel is covered by the at least one occluding object in the occluder depth map.

28. The method of claim 19, further comprising:
configuring the visibility mask prior to configuring the pattern mask configuration associated with the visibility mask, and wherein calculating the depth value for each of the first set of pixels further comprises: calculating an amount of bits for the depth value for each of the first set of pixels.

29. An apparatus for graphics processing, comprising:
means for obtaining pixel information for a plurality of pixels in at least one frame, the at least one frame being included in a plurality of frames in a scene;
means for calculating a depth value for each of a first set of pixels of the plurality of pixels;
means for identifying whether each of the first set of pixels or a second set of pixels, or both, is occluded by at least one occluding object in the scene, wherein the second set of pixels is included in the plurality of pixels;
means for configuring a pattern mask configuration associated with a visibility mask for the plurality of pixels, the pattern mask configuration including a first pattern portion corresponding to the first set of pixels and a second pattern portion corresponding to the second set of pixels; and
means for outputting, based on the pattern mask configuration, an indication of the depth value for each of the first set of pixels and coverage information for each of the first set of pixels or the second set of pixels, or both, wherein the coverage information is associated with whether each of the first set of pixels or the second set of pixels, or both, is occluded by the at least one occluding object in the scene.

30. A computer-readable medium storing computer executable code for graphics processing, the code when executed by a processor causes the processor to:
obtain pixel information for a plurality of pixels in at least one frame, the at least one frame being included in a plurality of frames in a scene;
calculate a depth value for each of a first set of pixels of the plurality of pixels;
identify whether each of the first set of pixels or a second set of pixels, or both, is occluded by at least one occluding object in the scene, wherein the second set of pixels is included in the plurality of pixels;
configure a pattern mask configuration associated with a visibility mask for the plurality of pixels, the pattern mask configuration including a first pattern portion corresponding to the first set of pixels and a second pattern portion corresponding to the second set of pixels; and
output, based on the pattern mask configuration, an indication of the depth value for each of the first set of pixels and coverage information for each of the first set of pixels or the second set of pixels, or both, wherein the coverage information is associated with whether each of the first set of pixels or the second set of pixels, or both, is occluded by the at least one occluding object in the scene.
